(19) United States
(12) Patent Application Publication
(10) Pub. No.: US 2008/0210652 A1
(43) Pub. Date: Sep. 4, 2008

(54) Hydraulic Motors for Actuating and Controlling an Anti-Swing System in Container-Handling Granes

(75) Inventors: Miguel Angel Tavio Diaz, San Roque (ES); Manoli Vilchez Vilchez, Algeciras (ES)

Correspondence Address: CANTOR COLBURN, LLP, 20 Church Street, 22nd Floor, Hartford, CT, 06103, US

(73) Assignee: MAERSK ESPANA S.A., ALGECIRAS (ES)

(21) Appl. No.: 11/914,173

(22) PCT Filed: Nov. 3, 2005
(86) PCT No.: PCT/ES2005/000607

§ 371 Date: Feb. 19, 2008

(30) Foreign Application Priority Data
May 10, 2005 (ES) P200501200

(51) Int. Cl. B66C 13/06

(52) U.S. Cl. 212/273

(57) ABSTRACT

The invention relates to hydraulic motors for actuating and controlling an anti-swing system in container-handling cranes. Container-handling cranes pose the following problem, namely that, when the trolley moves, the cables supporting the load spreader oscillate longitudinally in relation to the aforementioned movement. Systems currently used to reduce said swinging movement are inconvenient because (i) they comprise numerous power transmission elements, thereby generating maintenance problems, and (ii) the main two functions thereof are performed separately, i.e. movement transmission and oscillation reduction. The aforementioned problems can be resolved with an autonomous, independent drive system using hydraulic motors, thereby rendering the power transmission drive chain simple, robust, reliable and easy to maintain. In addition, the motors perform the main functions simultaneously, i.e. producing the movement and reducing the oscillations. According to the invention, pressure-limiting devices are used to dampen the pressure points applied to the motors during the swinging movement. The system balances the pressure on the motors and, in this way, offsets the oscillating movement.

### TECHNICAL FIELD OF THE INVENTION

Industrial sector: container transportation and movement.

Anti-swing system for container-handling cranes.

### BRIEF DESCRIPTION OF THE RELATED ART

Some systems are known for controlling the swinging movement of the load in container-handling cranes.

An anti-swing system can be cited comprising the following elements:
4 drums connected by pairs, in which the anti-swing cables are wound. Each pair of drums is connected to the same shaft and allows free rotation in a single sense.
1 electric disc brake connected to one of the ends of each shaft.
4 constant-torque motors with forced ventilation.
4 reducers.
4 sets of gears (formed by three crowns) in charge of transmitting the motion of the reducers to the drums.

The operation is as follows: during the descent operation, the drum brake is open and allows rotation of the drums in both directions.

The entire retaining load of the cables falls on the motors and their reducers. During a stopped lifting or elevation, the brake locks the shaft and allows the motors to move only in the cable winding direction. Movement in the opposite direction is locked by free wheels with unidirectional rotation rollers placed on the outer end of each drum.

In this way, the swinging motion of the spreader or the load will be supported by two of the cables, releasing the other two, which are wound in by their corresponding drums so that the cable cannot move when the opposite swinging motion takes place.

In theory, the alternating locking of the 4 cables will allow reducing the oscillation and swinging.

The drawbacks of this system, in addition to its limited ability to reduce the swinging, are the loads supported by the free wheels, which are violent and continued and eventually destroy them, rendering the system useless and requiring to disassemble all its elements in order to replace them.

Another system known solves the swinging problem as follows: 4 drums on one shaft to which the movement is transmitted from the main elevation drum (transmission chain or gears). 4 hydraulic cylinders mounted on the spreader that damp the oscillatory motion. The anti-swing drum must be placed very close to the main elevation drum in order to transmit it motion.

In any case:

These systems have many elements in the power transmission. This implies maintenance problems when dealing with large loads.

The two main functions are performed separately: on one hand they transmit the motion and on another they reduce oscillations.

### BRIEF SUMMARY OF THE INVENTION

Container-handling cranes present the following problem: when the carriage is driven in one direction, the cables supporting the spreader (the element that engages the container) and the load tend to swing in a direction longitudinal to their motion. A certain time is required before the container can be deposited in its intended location to allow this oscillation to stop and the spreader-load assembly to stabilise.

FIG. 1 shows a graphical representation of this problem (in an exaggerated manner).

The invention provides 4 hydraulic motors connected directly to the 4 drums. Each drum houses one of the four cables (anti-swing cables) in charge of minimising the oscillations.

The arrangement of the drums is not determinant in this system, contrary to the case in other systems.

Traditionally, the two main functions are performed separately: on one hand the movement must be transmitted, and on the other the oscillations must be reduced. In the system proposed, the hydraulic motors perform both functions simultaneously: they produce the motion and at the same time dampen the oscillation.

Pressure limiting devices installed in the hydraulic centre are used to dampen the pressure peaks produced on each of the motors during swinging. The system balances the pressure on the motors and thereby neutralises the oscillatory motion.

Actuation of the motors requires a hydraulic centre comprising a pump connected to an electric motor, a tank and three perfectly differentiated blocks:
Load and recirculation block
Actuation block
Anti-swing block

### Operation.

### Load and Recirculation Block

It is in charge of maintaining a certain pressure level. With the aid of an accumulator and controlled by a pressostat, it activates an electrovalve that disconnects the load from the system and recirculates the oil to the tank when the nominal working pressure is attained.

It incorporates a limiting valve that acts as a safety measure in case of system failure.

### Actuation Block

In charge of transmitting the motion to the motors in the upward elevation sense and limits the oil flow when the motors are carried in the downward sense, maintaining the tension of the cables at all times.

Two 3-way electrovalves with a closed centre allow switching between the three operation states of the motor (elevation, idle and descent).

### Anti-Swing Block

Two unidirectional or rectifying plates are used to channel pressure surges from the motors to a limiting valve in charge of dampening the oscillations of the spreader-load assembly.

An open centre electrovalve is used to allow free passage of the flow, which is restricted by a low-flow strangulation valve that acts during the approach manoeuvre of the spreader to the load.

Another limiting valve is provided in the pressure line to absorb surges caused during the reverse sense motion.

The cable attachment to the spreader is provided with a dampening system to minimise the fatigue of the cables and anchorings.

### BRIEF DESCRIPTION OF THE DRAWINGS

FIG. 1 shows a general elevation view of a container-handling crane and the technical issue considered: when the spreader-load assembly (suspended by the elevation cables) moves horizontally, an oscillatory motion (swinging) occurs that requires the crane operator to wait a certain time before depositing the load.

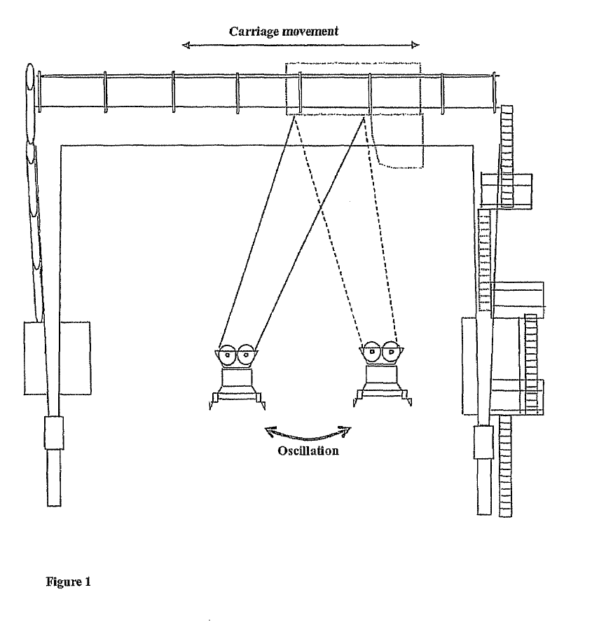

FIG. 2 shows a simplified schematic representation of the system: The tank, motor and pump assembly; the three blocks for loading, actuation and control. The motors coupled directly to the drums, from which leave the four anti-swing cables to the spreader, after passing through pulleys placed in the carriage. The purpose of the pulleys is to establish the proper angle of the cables with respect to the spreader.

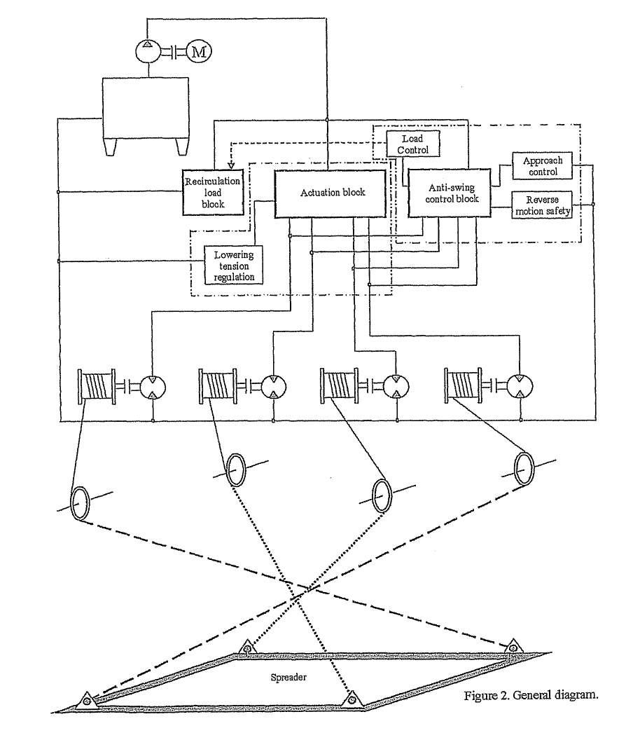

FIG. 3 shows an example of embodiment of the system.

### DETAILED DESCRIPTION OF THE INVENTION

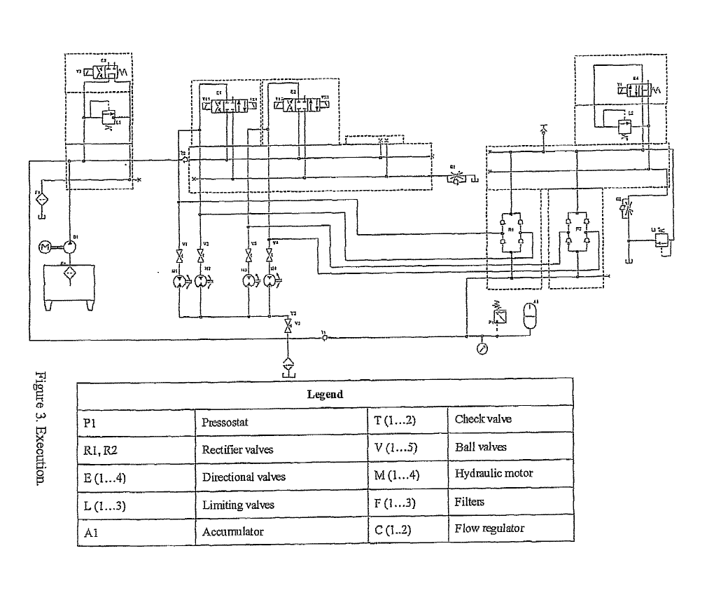

FIG. 3 shows an embodiment (among several possibilities) of the invention. The mechanical transmission can be made more complex by the use of reducers, the number of independently actuated branches can be varied. The hydraulic circuit represented is characterised by the use of the aforementioned blocks, not by the specific valves used.

1. System of hydraulic motors to actuate and control a swinging motion of a spreader or a spreader and a load assembly that occurs in container-handling cranes, the system comprising:
a fully autonomous system, both from a power and mechanical point of view not connected to other crane systems,
as many hydraulic motors as drums;
no transmission of movement between anti-swing drums and a main actuation of elevation;
wherein the system is configured to transmit motion to cables through the drums and limit the swinging motion;
the anti-swing motors are disposed on the crane or on the spreader; and
the system further comprising a hydraulic circuit including:
a movement actuation block;
an anti-swing block; and
a circuit loading block;
